(19) United States
(12) Patent Application Publication
(10) Pub. No.: US 2025/0086431 A1
(43) Pub. Date: Mar. 13, 2025

(54) ACCELERATING COMPLEX WORKLOADS USING SPARSE FAST CHEBYSHEV INTERPOLATION

(71) Applicant: QUALCOMM Incorporated, San Diego, CA (US)

(72) Inventors: Pierre-David LETOURNEAU, Philadelphia, PA (US); Dalton James JONES, Golden, CO (US); Matthew James MORSE, New York, NY (US); Matthew Harper LANGSTON, Beacon, NY (US)

(21) Appl. No.: 18/462,872

(22) Filed: Sep. 7, 2023

(51) Int. Cl. G06N 3/0455; G06F 17/16; G06N 3/0464

(52) U.S. Cl. CPC G06N 3/0455; G06F 17/16; G06N 3/0464

(57) ABSTRACT

Certain aspects of the present disclosure provide techniques and apparatus for executing a workload on a computing device based on an approximation of a target function. An example method generally includes generating a plurality of sample points from a multi-dimensional space representing domain of a target function. A plurality of sparse matrices is generated from the plurality of sample points, each respective sparse matrix being generated based on known non-zero coefficients of the target function. A plurality of transformed sparse matrices representing a relationship between Chebyshev coefficients of the target function and the plurality of sample points after applying lower dimensional cosine transformations are generated. An approximation of the target function is generated based on the plurality of transformed sparse matrices. An output of at least a portion of a neural network may be generated based on the approximation of the target function.

### INTRODUCTION

Aspects of the present disclosure relate to accelerating complex workloads.

Complex workloads, such as those involved in signal processing, training machine learning models, performing convolution operations in convolutional neural networks, computing attention in a transformer neural network, and the like, generally involve complex mathematical operations executed in a multidimensional space. Because these complex workloads generally scale in compute complexity (e.g., in terms of the amount of processing cycles used in executing an operation, the amount of memory used to store data used in executing the operation, etc.) nonlinearly (e.g., in polynomial time or nondeterministic polynomial time), executing these complex workloads generally uses significant amounts of computational resources and may be impractical to perform under various resource constraints. The complexity involved in and practicality of executing these complex workloads may be influenced by the dimensionality of the data processed as a part of a complex workload. A workload involving low-dimensional data may be practical to execute under various resource and/or time constraints, such as those imposed by executing a workload on a mobile device or other computing device with limited computational resources or by executing a workload in which outputs are to be generated in near-real-time or some other short time after an input is received. A workload involving high-dimensional data, however, may not practically be performed on a computing device with limited computational resources or may not be able to be executed in compliance with various timing constraints.

### BRIEF SUMMARY

Certain aspects of the present disclosure provide a method for executing a workload on a computing device based on an approximation of a target function. An example method generally includes generating a plurality of sample points from a multi-dimensional space representing domain of a target function, each respective sample point of the plurality of sample points being generated based on one or more selected sampling rates for each dimension in the multi-dimensional space. A plurality of sparse matrices is generated from the plurality of sample points, each respective sparse matrix being generated based on known non-zero coefficients of the target function. A plurality of transformed sparse matrices representing a relationship between Chebyshev coefficients of the target function and the plurality of sample points after applying lower-dimensional cosine transformations are generated. An approximation of the target function is generated based on the plurality of transformed sparse matrices. An output of at least a portion of a neural network may be generated based on the approximation of the target function.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example pipeline for processing a complex workload based on sparse Chebyshev interpolation of a target function, according to aspects of the present disclosure.

FIG. 2 illustrates an example digital pre-distorter (DPD) and power amplifier (PA) architecture which can be modeled using an approximation of a target function generated based on sparse Chebyshev interpolation of the target function, according to aspects of the present disclosure.

FIG. 3 is a block diagram illustrating a deep convolutional network (DCN) in which at least a portion of the DCN can be modeled using an approximation of a target function generated based on sparse Chebyshev interpolation of the target function, according to aspects of the present disclosure.

FIG. 4 illustrates an example transformer neural network architecture in which at least a portion of the transformer neural network can be modeled using an approximation of a target function generated based on sparse Chebyshev interpolation of the target function, according to aspects of the present disclosure.

FIG. 5 illustrates example operations for processing a complex workload based on sparse Chebyshev interpolation of a target function, according to aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently processing a complex workload based on sparse Chebyshev interpolation of a target function.

Many workloads, such as modeling of a digital and/or analog circuit or training or inferencing using machine learning models, can be represented by a target function that uses a number of inputs and operations defined for each of these inputs in order to generate an output. For a modeled digital and/or analog circuit, the inputs may correspond to various parameters of components in the circuit, and the output may correspond to various measurements such as a signal-to-noise ratio, power consumption measurement, or the like. For a machine learning model, the inputs may correspond to multidimensional data that is input into the model, and the output may correspond to an inference generated by the model from the input data, such as a prediction, a classification, or the like.

Generally, these workloads may increase in complexity in a nonlinear fashion approaching infinity as the dimensionality of the input data increases. That is, the computational complexity, and thus the amount of computing resources (e.g., processing cycles, memory utilization, etc.) used in executing these workloads, may scale nonlinearly as the amount of data increases. To accelerate execution of these workloads, various approximation techniques can be used. For example, Chebyshev polynomials, which allow for the representation and interpolation of polynomials over the region [₁,]^{D}, as a series according to the expression:

$${\sum }_{n} {p}_{n} {\prod }_{i = 1}^{D} {T}_{{n}_{i}} ( {x}_{i} )$$

where ρ represents a specific polynomial, n represents a number of polynomials representing the target function, D corresponds to a dimensionality of a space in which the target function lies, T corresponds to a polynomial related to a cosine function, x represents an input into the target function, and i corresponds to an index.

Because Chebyshev interpolation and related cosine transforms (e.g., discrete cosine transforms (DCTs)) have the properties of numerical stability and demonstrable approximation power, Chebyshev interpolation and DCTs can be used in accelerating the performance of various operations, such as those involving partial differential equations, signal processing techniques, optimization of a system represented by a complex target function, and the like. However, Chebyshev interpolation is also subject to nonlinear growth in computational complexity, as discussed above. For example, the DCT exhibits quasi-linear computational complexity scaling in lower-dimensionality spaces. As the number of dimensions of input data processed by a target function increase, the computational expense increases exponentially (e.g., has a computational complexity of O(2ⁿ), where n corresponds to the number of dimensions of the input data). In another example, in matrix inversion and matrix-based least-squares operations, the computational complexity to recover coefficients in a polynomial function generally scales quadratically (e.g., has a computational complexity of O(n²), where n corresponds to the number of dimensions of the input data). Further, some techniques can reduce the number of multiplication operations by a factor of

$$\frac{1}{D} ;$$

however, these techniques do not incorporate knowledge of where non-zero Chebyshev coefficients are located in an approximation of a target function and may restrict which polynomial coefficients can be efficiently recovered.

Aspects of the present disclosure provide techniques for accelerating the execution of complex workloads using fast Chebyshev transformations in high-dimensional data. As discussed in further detail herein, a high-dimensional function may be represented by a polynomial with coefficients generated based on random sampling in each of a plurality of dimensions in the data. The samples may be processed using sparse matrices (e.g., matrices with a large number of zero values) and a DCT (or another appropriate mathematical transform). Unknown polynomial coefficients may then be solved for in order to generate an approximation of a target function, where the approximation can be used to efficiently generate an output of the target function for a given input. Because the techniques discussed herein take advantage of many polynomial coefficients in a polynomial interpolation of a target function being zero, and thus that the target function need not be uniformly sampled in each dimension, aspects of the present disclosure can significantly reduce the computational expense involved in generating an approximation of a target function. For example, the techniques discussed herein can generate an approximation of a target function, including identifying the values of coefficients in the approximation of the target function, with a complexity that scales quasi-linearly with the number N of non-zero Chebyshev coefficients (e.g., with a computational complexity of O(N polylog(N))), regardless of the number of dimensions in the input data.

### Example Chebyshev Interpolation of a Target Function

To process a complex workload defined by a target function, aspects of the present disclosure provide for generating an approximation of the target function including a number of Chebyshev polynomials with non-zero coefficients. To do so, given a dimension D, a multidimensional polynomial function ρ(x)=ρ(x₁, . . . , x_{D}) may be expanded in a Chebyshev function of the form:

$$p ( x ) = {\sum }_{n ∈ supp ( p )} {p}_{n} ( {\sum }_{i = 1}^{D} {T}_{{n}_{i}} ( {x}_{i} ) )$$

where x=(x₁, . . . , x_{D})∈[−1,1]^{D}. {Tₙ_{ᵢ}(xᵢ)} represents one-dimensional Chebyshev polynomials such that Tₙ_{ᵢ}(xᵢ)=cos(nᵢ arccos(xᵢ)) for i=1, . . . , D. n=(n₁, . . . , n_{D})∈ [symbol] ^{D} correspond to multi-indices, and supp(ρ):={n∈ [symbol] ^{D}: ρₙ≠0} represents the set of non-zero coefficients of the polynomial ρ that correspond to the support of ρ. A polynomial with dense support may be a polynomial with a degree d such that supp(ρ)={n∈ [symbol] ^{D}:∥n∥≤d}, where ∥n∥ is the norm (e.g., an L1 norm, an L2 norm, etc.) of the multi-index n. Further, dense support of the L1 norm in degree d in D dimensions has a cardinality defined by the expression:

$$\# supp ( p ) = ( \begin{matrix}D + d \\ d\end{matrix} ) = O ( min ( {D}^{d} , {d}^{D} ) )$$

The cardinality is thus polynomial in dimension and generally scales polynomially in dimension, regardless of the choice of the norm used for the multi-indices.

The approximation of a target function may begin with knowledge of the support supp(ρ) of a polynomial p, for which Chebyshev coefficients are to be recovered. To recover these coefficients efficiently, and thus to approximate a target function efficiently, aspects of the present disclosure use O(N) samples and O(N polylog(N)) operations, where N≠#supp(ρ) corresponds to the number of nonzero coefficients in the support of the polynomial ρ.

In some examples, a DCT can be used to generate an approximation of the target function based on Chebyshev interpolation. A DCT-based technique leverages the fact that Chebyshev polynomials obey the identity relationship Tₙ_{ᵢ}(cos(θᵢ))=cos(nᵢθᵢ) following a change of variable. Because a Chebyshev polynomial has this identity relationship, DCT-based techniques transform the expression

$$p ( x ) = {\sum }_{n ∈ supp ( p )} {p}_{n} ( {\sum }_{i = 1}^{D} {T}_{{n}_{i}} ( {x}_{i} ) )$$

into a multi-dimensional cosine series. The corresponding Chebyshev coefficients can then be computed by sampling the multidimensional cosine series at Chebyshev nodes and applying a DCT to the sampled multidimensional cosine series. While this example allows for the approximation of a target function, quasi-linear algorithms generally do not leverage the sparsity of support and therefore use a full sampling grid in each dimension in order to identify the corresponding Chebyshev coefficients for an approximation of the target function. Thus, a DCT-based approximation of the target function may have a sampling rate of O(d^{D}) and a computational cost of O(d^{D} log(d^{D})), both of which are exponential in dimension (e.g., increase exponentially as the dimensionality of the input increases).

In another example, a least-squares approach can be used to generate an approximation of the target function based on Chebyshev interpolation. Using a least-squares approach, an interpolation matrix may be created according to the expression:

$${[ B ]}_{i , j} = {T}_{n ( j )} ( {x}^{( i )} )$$

where x⁽ⁱ⁾ corresponds to sample points in the multidimensional space in which the target function lies and {n(j)} is a specific ordering of the multi-indices in the support of a polynomial ρ representing an approximation of the target function. The matrix B generally has a number of columns corresponding to the support #supp(ρ) and a number of columns scaling on the order of O(N) and is chosen such that the matrix B has full column rank. After the matrix B is constructed, missing coefficients of the polynomial approximation of the target function can be recovered by solving the least squares problem, min/ρ∥Bₚ−π∥₂², where π is a vector containing samples π₁=ρ(x⁽ⁱ⁾) and ρ is a vector containing the Chebyshev coefficients of the polynomial approximation of the target function.

A least-squares approach to generating an approximation of a target function may be computationally expensive. For example, iterative techniques which use dense matrix vector products to recover unknown Chebyshev coefficients may have a computational cost of O(N²). Direct techniques, such as Gaussian elimination, may have a computational cost of O(N³). Because of the computational cost involved in least-squares approaches, it may become increasingly computationally impracticable to generate an approximation of a target function as the dimensionality of the target function increases and as the size of the support increases.

### Example Fast Chebyshev Transform-Based Interpolation of a Target Function

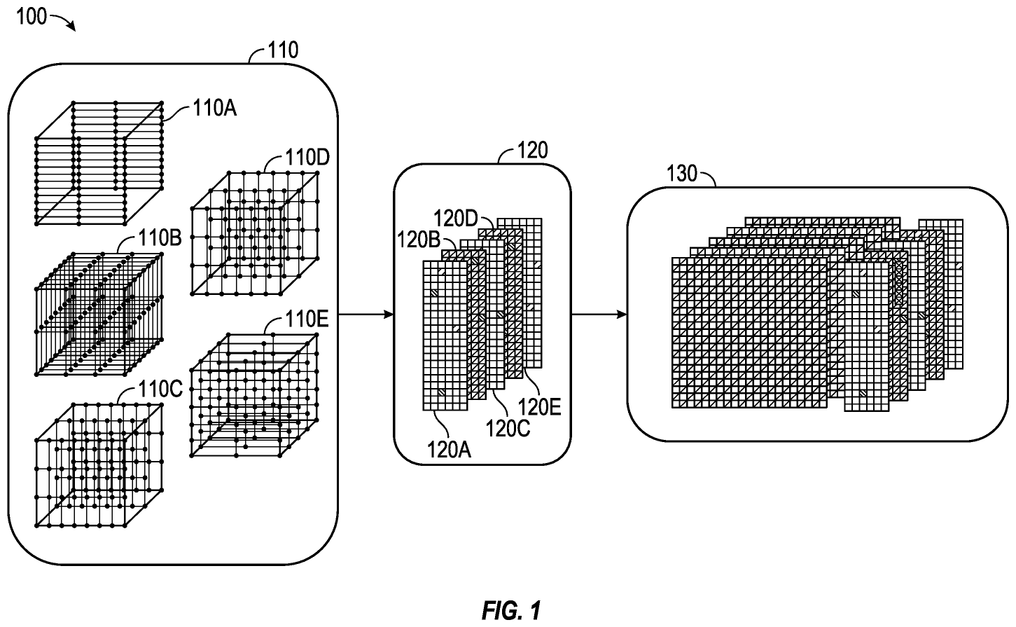

FIG. 1 illustrates an example pipeline 100 for processing a complex workload based on sparse Chebyshev interpolation of a target function, according to aspects of the present disclosure.

To approximate a target function, the pipeline 100 may be based on a linear system according to the expression:

$$[ \begin{matrix}{π}^{( 1 )} \\ {π}^{( 2 )} \\ … \\ {π}^{( L )}\end{matrix} ] = [ \begin{matrix}{F}^{( 1 )} & 0 & … & 0 \\ 0 & {F}^{( 2 )} & … & 0 \\ … & … & … & … \\ 0 & 0 & … & {F}^{( L )}\end{matrix} ] [ \begin{matrix}{A}^{( 1 )} \\ {A}^{( 2 )} \\ … \\ {A}^{( L )}\end{matrix} ] p$$

In this linear expression, each matrix A may be a sparse NL×N matrix including L sparse blocks corresponding to the number of sample points generated in approximating the target function and O(N) non-zero entries. The block matrices F⁽ⁱ⁾ are matrices corresponding to a discrete cosine transform. ρ=(ρ₀, ρ₁, . . . , ρ_{N}) is a vector of unknown Chebyshev polynomial coefficients, and each ƒ⁽¹⁾, . . . , ƒ^{(L)} represents different samplings of a target function ƒ. The linear system leverages aliasing properties of Chebyshev polynomials, in which a higher-degree Chebyshev polynomial generates the same values as a low-degree Chebyshev polynomial on a fixed grid size. Because of this property, it may be assumed that if a low-degree Chebyshev polynomial is zero on a grid (e.g., tensor product grid 110, illustrated in FIG. 1 and described in further detail below), some higher-degree Chebyshev polynomials will also be zero on that same grid.

In a one-dimensional space, the objective of the pipeline 100 may be to find a one-dimensional interpolation (or approximation) of a target function ƒ by a degree N Chebyshev polynomial. To do so, the pipeline 100 is used to generate an approximation of the target function ƒ such that:

$$f ( x ) \approx p ( x ) = {\sum }_{n = 1}^{N} {a}_{n} {T}_{n} ( x )$$

$$where x ∈ [ - 1 , 1 ]$$

$$and {a}_{n} = \frac{2}{π} {\int }_{- 1}^{1} \frac{{T}_{n} ( x ) f ( x )}{\sqrt{1 - {x}^{2}}} d x$$

After converting x to x=cos(θ) and translating the problem of generating the one-dimensional interpolation of the target function ƒ into the range [0, π], the interpolation problem may be converted to the expression:

$$f ( cos ( θ ) ) \approx p ( cos ( θ ) ) = {\sum }_{n = 1}^{N} {a}_{n} cos ( n θ )$$

$$where θ ∈ [ 0 , π ]$$

$$and {a}_{n} = {\int }_{- 1}^{1} cos ( n θ ) f ( cos ( θ ) ) d θ$$

Substituting the polynomial approximation of ƒ for the n^{th} Chebyshev coefficient:

$${a}_{n} \approx {\int }_{0}^{π} cos ( n θ ) ( {\sum }_{m = 0}^{N} {a}_{m} cos ( m θ ) ) d θ = {\sum }_{m = 0}^{N} {a}_{m} {\int }_{0}^{π} cos ( n θ ) cos ( m θ ) d θ$$

By discretizing the integral ∫₀^{π} cos(nθ) cos(mθ)dθ using equally spaced points in [θ, π], corresponding to a Chebyshev grid of N+1 points, represented by the expression:

$${θ}_{k} = \frac{( k + \frac{1}{2} ) π}{N + 1} , k = 0 , … , N$$

the quadrature approximation of αₙ may be represented by the expression:

$${a}_{n} \approx \frac{1}{N + 1} {\sum }_{m = 0}^{N} {a}_{m} {\sum }_{k = 0}^{N} cos ( n {θ}_{k} ) cos ( m {θ}_{k} )$$

where

$$\frac{1}{N + 1}$$

represents the quadrature weight for the trapezoidal rule for approximating a definite integral. Because of the orthogonality and aliasing properties (discussed above) of cosines on equispaced grids, the values of n and m may be determined efficiently when the quadrature sum is a non-zero value.

The aliasing identity may extend to functions with higher dimensionality processed through the pipeline 100, where a scalar value between [−1,1] is generalized to vectors [−1,1]^{D}. Chebyshev interpolation of a function ƒ: [−1,1]^{D}→ [symbol] involves tensor product polynomials and a replacement of the single index n in the equations above with the multi-index n=(n₁, . . . , n_{D}). In interpolation of a multidimensional functional, the function ƒ may be approximated according to the expression:

$$f ( x ) \approx p ( x ) = {\sum }_{n = 0}^{N} {a}_{n} {T}_{n} ( x ) \\ where \\ x ∈ {[ - 1 , 1 ]}^{D} , \\ {a}_{n} = \frac{2}{π} {\int }_{{[ - 1 , 1 ]}^{D}} \frac{{T}_{n} ( x ) f ( x )}{\sqrt{1 - {x}^{2}}} dx , \\ and \\ {T}_{n} ( x ) = {T}_{{n}_{1}} ( {x}_{1} ) {T}_{{n}_{2}} ( {x}_{2} ) … {T}_{{n}_{d}} ( {x}_{D} )$$

Using the same change of variables in each dimension as that discussed above with respect to the interpolation of a one-dimensional function, the target function ƒ may be represented by the expression:

$$f ( cos ( θ ) \approx p ( cos ( θ ) ) = {\sum }_{n = 0}^{N} {a}_{n} cos ( n θ ) \\ where \\ θ ∈ {[ 0 , π ]}^{D} \\ and \\ {a}_{n} = {\int }_{{[ 0 , π ]}^{D}} cos ( n θ ) f ( cos ( θ ) ) d θ ,$$

where θ=(θ₁, . . . , θ_{D}) and cos(nθ)=cos(n₁θ₁) cos(n₂θ₂) . . . cos(n_{D}θ_{D}).

The resulting approximation of an may be represented by the expression:

$${a}_{n} \approx {\sum }_{m = 0}^{N} {a}_{m} {\int }_{{[ 0 , π ]}^{D}} cos ( n θ ) cos ( m θ ) dθ = {\sum }_{m = 0}^{N} {a}_{m} {\int }_{{[ 0 , π ]}^{D}} ( {\prod }_{i = 0}^{D} cos ( {n}_{i} {θ}_{i} ) ) ( {\prod }_{i = 0}^{D} cos ( {m}_{i} {θ}_{i} ) ) d θ = {\sum }_{m = 0}^{N} {a}_{m} {\prod }_{i = 0}^{D} {\int }_{0}^{π} cos ( {n}_{i} {θ}_{i} ) cos ( {m}_{i} {θ}_{i} ) d {θ}_{i}$$

By discretizing the integral ∫₀^{π} cos(nᵢθᵢ) cos(mᵢθᵢ) dθᵢ in the equation above, the quadrature approximation of an may be represented by the expression:

$${a}_{n} \approx \frac{1}{{( N + 1 )}^{D}} {\sum }_{m = 0}^{N} {a}_{m} {\prod }_{i = 0}^{D} ( {\sum }_{k = 0}^{N} cos ( {n}_{i} {θ}_{k} ) cos ( {m}_{i} {θ}_{k} ) ) = {\sum }_{m = 0}^{N} {a}_{m} ( {\prod }_{i = 0}^{D} \frac{1}{2} {Δ}_{N} ( {m}_{i} + {n}_{i} ) + \frac{1}{2} {Δ}_{N} ( {m}_{i} - {n}_{i} ) )$$

The resulting D-dimensional sparsity pattern A_{n,m} may thus be represented by the expression:

$${A}_{n , m} = {\prod }_{i = 1}^{D} \frac{1}{2} {Δ}_{N} ( {m}_{i} + {n}_{i} ) + \frac{1}{2} {Δ}_{N} ( {m}_{i} - {n}_{i} )$$

where n, m are multi-indices and where the row and columns of A are indexed by multi-indices according to a consistent ordering scheme. That is, the (n, m)-entry of A may be defined as the product of the (nᵢ, mᵢ)-entries of the corresponding one-dimensional system matrix Aⁱ constructed on the it dimension according to the expression:

$${A}_{n , m} = {\prod }_{i = 0}^{E} {A}_{{n}_{i} , {m}_{i}}^{i}$$

The resulting full matrix A may be expressed as a Kronecker product of the Aⁱ defined for each dimension in the multidimensional space. Thus, A_{n,m}=A¹⊗A²⊗ . . . ⊗A^{D}. Because each Aⁱ is a sparse matrix, each Kronecker product may be efficiently computed by examining the non-zero entries in each matrix.

In some aspects, different grid sizes may be supported in each dimension in a multidimensional space. If the i^{th} dimension is discretized with Nᵢ+1 points, the multi-index N may be replaced with N̅=(N₁, N₂, . . . , N_{D}) in the expressions above. In such a case, the multi-indices nᵢ and mᵢ may range from 0 to Nᵢ instead of from 0 to N, and the definition of a D-dimensional sparsity pattern A_{n,m} may thus be represented by the expression:

$${A}_{n , m} = {\prod }_{i = 1}^{D} \frac{1}{2} {Δ}_{{N}_{i}} ( {m}_{i} + {n}_{i} ) + \frac{1}{2} {Δ}_{{N}_{i}} ( {m}_{i} - {n}_{i} )$$

In the pipeline 100, to generate sampling points based on which the target function can be interpolated and approximated, a series of tensor product grids 110A-110E (collectively referred to hereinafter as “tensor product grids 110”) may be generated. Each of these tensor product grids may determine the sampling pattern of ƒ and the sparsity pattern of A and may include different numbers of randomly selected points in each dimension. In some aspects, each tensor product grid may have a total number of sample points that approximates N (i.e., the number of non-zero coefficients in the approximation of the target function). As illustrated, the tensor product grids 110A through 110E (amongst others not illustrated in FIG. 1) may be generated based on varying sampling rates in each dimension of the multidimensional space. Intersections of gridlines in the multidimensional space may represent points at which a grid is sampled in order to generate the sampling points based on which the target function can be interpolated and approximated. Generally, each of the tensor product grids 110 can be defined according to the expression N=⁽ [symbol] ⁾=(N₁⁽ [symbol] ⁾, . . . , N_{D}⁽ [symbol] ⁾) for [symbol] =1, . . . L, where [symbol] represents a specific choice of tensor-product discretization in each dimension in a item multidimensional space, with size Πᵢ₌₁^{D}Nᵢ⁽ [symbol] ⁾.

To generate the tensor product grids 110 and the number of the tensor product grids 110 to generate in approximating a target function ƒ, the number of grids L may be selected such that the linear system is well-conditioned, invertible, and efficient to solve. To ensure that the linear system is invertible, the tensor product grids may be selected to satisfy the expression:

$${\sum }_{ℓ = 1}^{L} ( {\prod }_{i = 1}^{D} {N}_{i}^{( ℓ )} ) \geq N$$

However, because setting Nᵢ⁽ [symbol] ⁾=1 provides insufficient resolution for resolving ƒ in the i^{th} dimension, a randomized approach may be used to generate the tensor product grids 110. For each [symbol] =1, . . . , L, a uniformly random integer vector N( ) may be selected with components between 0 and d such that the product of these components is approximately N. The resulting randomly selected tensor product grids 110 may allow for the evaluation of the target function at the grid points in each tensor product grid 110A-110E (amongst others) with a sufficient number of sample points that allows for the recovery of Chebyshev coefficients. To compute L, an iterative process may be performed to incrementally sample new randomly generated tensor product grids 110, construct corresponding matrices A 120 for the randomly generated tensor product grids 110, and append a matrix for a randomly generated tensor product grid 110 to the full matrix computed for previous grids. This process may terminate when A is a full-rank matrix and has a condition number (e.g., a measure of a magnitude by which an output changes for a given change in A) less than a defined lower bound.

Based on the tensor product grids 110, the pipeline 100 proceeds with generating matrices A 120 for each of the sample points. Each matrix A 120 (120A-120E) may be a sparse matrix generated based on the aliasing properties of Chebyshev polynomials discussed above. In generating the matrices A 120, an approximation an may be generated for a matrix A based on a corresponding tensor product grid 110 according to the equations:

$${\int }_{{[ 0 , π ]}^{D}} cos ( n θ ) f ( cos ( θ ) ) d θ \approx {\sum }_{m = 0}^{\overline{N}} {a}_{m} {\prod }_{i = 0}^{D} ( \frac{1}{2} {Δ}_{{N}_{i}} ( {m}_{i} + {n}_{i} ) + \frac{1}{2} {Δ}_{{N}_{i}} ( {m}_{i} - {n}_{i} ) )$$

$$and$$

$$\frac{1}{{\prod }_{i = 0}^{D} {N}_{i}} {\sum }_{k = 0}^{\overline{N}} cos ( n θ ) f ( cos ( θ ) ) \approx {\sum }_{m = 0}^{\overline{N}} {A}_{n , m} {a}_{m}$$

$$\frac{1}{{\prod }_{i = 0}^{D} {N}_{i}} {\sum }_{k = 0}^{\overline{N}} cos ( n θ ) f ( cos ( θ ) )$$

corresponds to a D-dimensional adjoint discrete cosine transform (DCT), while Σₘ₌₀^{N̅}A_{n,m}αₘ corresponds to the dot product of the n^{th} row of a matrix A with a vector of unknown coefficients α. In matrix form, the equation

$$\frac{1}{{\prod }_{i = 0}^{D} {N}_{i}} {\sum }_{k = 0}^{\overline{N}} cos ( n θ ) f ( cos ( θ ) ) \approx {\sum }_{m = 0}^{\overline{N}} {A}_{n , m} {a}_{m}$$

may become Fƒ=Aα, where F corresponds to a DCT matrix, ƒ corresponds to a vector of samples of a target function ƒ on a tensor product grid (e.g., one of the tensor product grids 110 illustrated in FIG. 1). While matrix sizes may grow exponentially as the dimensionality D of these matrices increases, when the target function ƒ is a smooth function, the use of polynomials of a bounded Euclidean degree may result in convergence on a geometric approximation of the target function. This convergence may be equivalent to choosing the set of non-negative multi-indices inside a defined area (e.g., a hypersphere with a radius d) in the coefficient space. Because the set of non-negative multi-indices is known α priori, an approximation of the target function ƒ (including the recovery of non-zero coefficients of Chebyshev polynomials in an approximation of the target function ƒ) may be calculated based on a summation over the multi-indices corresponding to the coefficients within this defined area, which may reduce the computational complexity involved in generating a Chebyshev approximation of a multidimensional target function.

Transformed sparse matrices 130 may be created based on the matrices A 120 (which, as discussed, are sparse matrices corresponding to different randomly sampled tensor product grids 110) and a DCT (or other appropriate cosine transformation). After the transformed sparse matrices 130 are generated, the Chebyshev coefficients of the target function can be recovered by solving a linear system via various techniques, such as a least-squares technique or the like. In recovering the Chebyshev coefficients using a least-squares technique, the approximation of the target function may be represented by the expression:

$${a}^{*} = arg {min}_{a} {‖ ( Ff - Aa ) ‖}_{2}^{2}$$

The least-squares problem may be solved using various techniques, such as a conjugate gradient (CG) technique, a singular value decomposition technique, or the like. When using a CG technique, because DCTs can be efficiently computed using a fast Fourier transform (FFT), computation of the matrix product Aa may be efficient due to the sparsity of matrix A, and matrix A generally exhibits rapid spectral decay properties, the recovery of Chebyshev coefficients representing a target function ƒ and approximation of the target function ƒ using these recovered Chebyshev coefficients may be performed efficiently. For example, generating an approximation of a target function via the pipeline 100 using the techniques described herein may have a computational complexity of O(N polylog(N)) operations, which scales significantly more slowly than techniques having a computational complexity of polynomial or nondeterministic polynomial time.

### Example Workloads Solvable Using Fast Chebyshev Transform-Based Interpolation of a Target Function

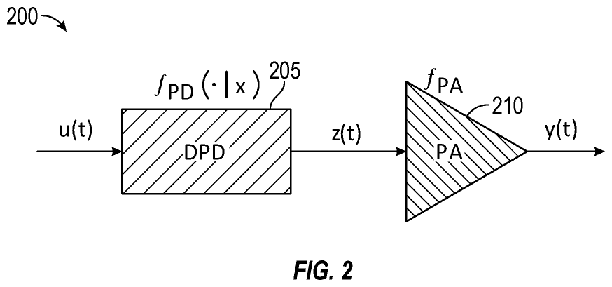

FIG. 2 illustrates an example amplifier architecture 200 including a digital pre-distorter (DPD) 205 and a power amplifier (PA) 210. Generally, the amplifier architecture 200 receives a baseband signal u(t), which is processed by the DPD 205 to compensate for distortion effects of the PA 210. The DPD 205 may be represented by a predistortion function ƒ_{PD}(·|x) and generates a predistorted output z(t) as input into the PA 210. The PA 210 applies an amplification function ƒ_{PA} to generate an output y(t), which generally represents the output of the amplifier architecture 200 (e.g., a radio frequency signal output by an antenna (not shown) coupled to the amplifier architecture 200). In other words, the output y(t) may be represented by the equation:

$$y ( t ) = {f}_{PA} ( {f}_{PD} ( \cdot \vert u ( t ) ) )$$

To determine parameters of the amplifier architecture 200 that satisfy a performance target or threshold, approximations of the target functions defining the DPD 205 and/or the PA 210 may be generated using techniques discussed above with reference to FIG. 1, including Chebyshev interpolation. For example, Chebyshev interpolation may be performed on ƒ_{PD} and/or ƒ_{PA} based on empirical data in order to identify Chebyshev coefficients corresponding to parameters that result in a target level of performance for the PA 210, the DPD 205, or the combination of the PA 210 and the DPD 205.

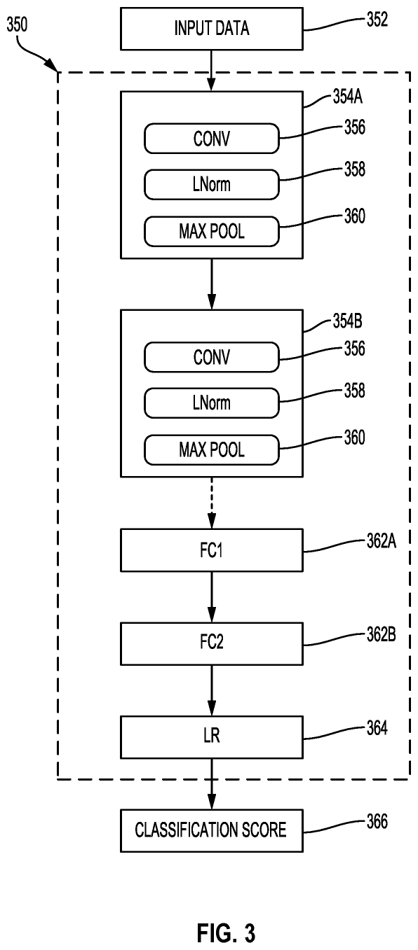

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes convolution blocks 354A, 354B. Each of the convolution blocks 354A, 354B may be configured with a convolution layer 356 (labeled “CONV”), a normalization layer 358 (labeled “LNorm”), and a max pooling layer 360 (labeled “MAX POOL”).

The convolution layers 356 may include one or more convolutional filters, which may be applied to the input data 352 to generate a feature map. Although only two convolution blocks 354A, 354B are shown, the present disclosure is not so limiting, and instead, any number of convolution blocks may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The deep convolutional network 350 may also include one or more fully connected layers, such as layer 362A (labeled “FC1”) and layer 362B (labeled “FC2”). The deep convolutional network 350 may further include a logistic regression (LR) layer 364. Each layer 356, 358, 360, 362, 364 of the deep convolutional network 350 generally are associated with weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the initial convolution block (e.g., the convolution block 354A). The output of the deep convolutional network 350 may be a classification score 366 for the input data 352. The classification score 366 may be a set of probabilities, where each probability is the probability of the input data including a feature from a set of features.

In some aspects, a function defining one or more convolutional layers 354 in the deep convolutional network 350 may be approximated using techniques discussed above with reference to FIG. 1, including Chebyshev interpolation. For example, the output of a convolutional layer 354 in the deep convolutional network 350 may be calculated based on the approximation of the target function. In another example, during training of the deep convolutional network 350, Chebyshev interpolation may be used to accelerate the process of identifying parameters (e.g., weights and/or biases) of these convolutional layers 354, as the convolutional layers 354 in the deep convolutional network 350 may be represented by a target function which can be accurately approximated using the techniques discussed herein.

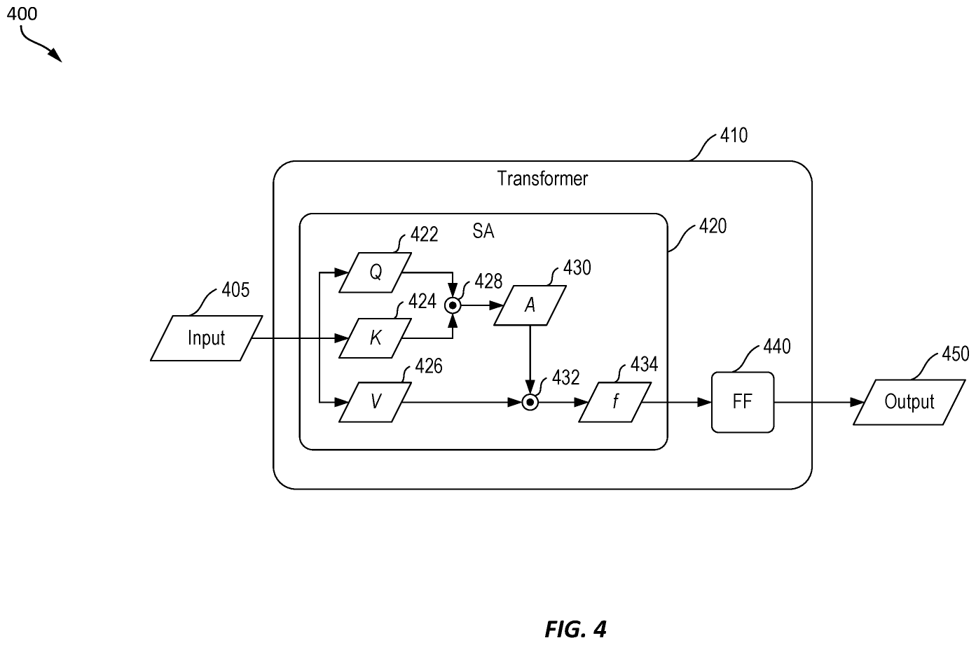

FIG. 4 illustrates an example transformer architecture 400 in which attention data is propagated through a transformer block in a neural network (e.g., for other transformer block(s) in the network) in order to generate an output of the neural network.

As illustrated in FIG. 4, input data 405 is accessed by a transformer 410. As used herein, accessing data can generally include receiving, retrieving, requesting, or otherwise gaining access to the data. As discussed above, the input data 405 may correspond to the input (e.g., raw or preprocessed input data) to the first transformer block of a model, the output of a prior transformer or other model component or block, and the like. For example, the input data 405 may correspond to a multidimensional input, a tokenized version of the multidimensional input (which may optionally include positional embedding(s) and/or learnable token(s)), or the like. The tokenized version of the multidimensional input may also be referred to as a set of features for the multidimensional input generated over different portions of the multidimensional input (e.g., different spatial portions, or patches, of the multidimensional input across multiple points in time).

Generally, the transformer 410 includes a self-attention block 420 (labeled “SA”) and a feedforward block 440 (labeled “FF”). In the self-attention block 420, the input data 405 may be linearly projected (e.g., multiplied using learned parameters) into three matrices: a query matrix Q 422 (also referred to in some aspects as a “query representation” or simply “queries”), a key matrix K 424 (also referred to in some aspects as a “key representation” or simply “keys”), and a value matrix V 426 (also referred to in some aspects as a “value representation” or simply “values”). For example, during training, one or more query weights, key weights, and value weights are learned based on training data, and the queries Q 422, the keys K 424, and the values V 426 can be generated by multiplying the input data 405 by the learned weights.

In some aspects, an attention matrix A 430 (also referred to as an “attention map” or simply “attention” in some aspects) is then generated based on the queries and keys. For example, the self-attention block 420 in the transformer 410 may, at operation 428, compute the dot product of the query matrix and the transposed key matrix (e.g., Q K^{T}). In some aspects, the self-attention block 420 can apply one or more operations (e.g., a row-wise softmax operation) to the dot product to yield that attention matrix. That is, the attention matrix A 430 may be defined as A=σ(Q·K^{T}), where σ is the softmax function (or some other regularizing function usable in a transformer neural network).

The self-attention block 420 may then generate resulting features ƒ 434. The resulting features ƒ 434 can be computed, at operation 432, as the dot product of the attention matrix A 430 and the value matrix V 426. The resulting features ƒ 434 can then be provided as input to the feedforward block 440 (e.g., a neural network or subnet) to generate an output 450 from the transformer 410. The output 450 may be used as an input into a subsequent transformer or other block in a neural network or may be the final result of processing an input through the neural network. The feedforward block 440, in some aspects, may be a multilayer perceptron (MLP) including a plurality of layers separated by an activation function, such as a Gaussian error linear unit activation function.

Although not depicted in FIG. 4, in some aspects, the transformer 410 may include one or more skip or residual connections (with or without layer normalization). For example, the output 450 may be generated by summing the output of the operation 432 with the input data 405, skipping the feedforward block 440. As another example, the output 450 of the transformer 410 may be generated by summing the output of the final layer of the feedforward block 440 with the previous version of the output 450.

In some aspects, a function defining the transformer neural network may be approximated using techniques discussed above with reference to FIG. 1. In some aspects, for example, the output (e.g., an attention output) of the transformer architecture 400 may be efficiently approximated using the techniques discussed above with reference to FIG. 1, including Chebyshev interpolation.

### Example Operations for Fast Chebyshev Transform-Based Interpolation of a Target Function

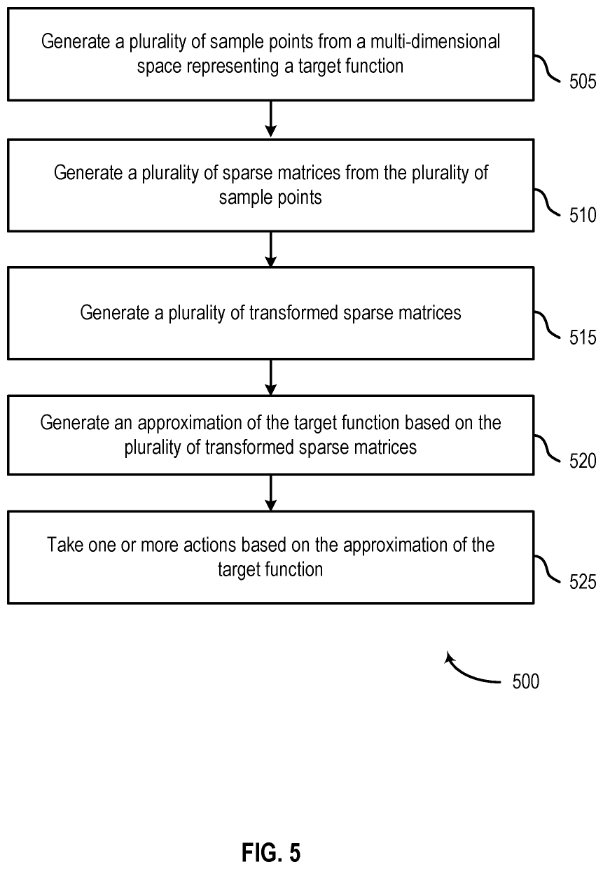

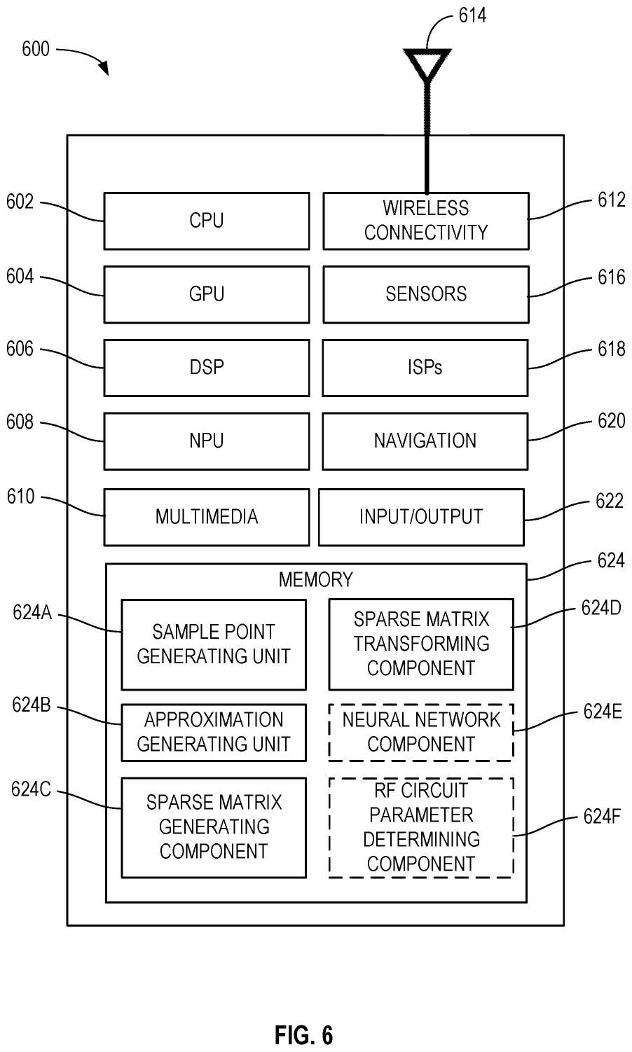

FIG. 5 shows an example of operations 500 which may be performed to efficiently generate an output of a target function using fast Chebyshev transformation-based interpolation of the target function, according to aspects of the present disclosure. The operations 500 may, in some aspects, implement the pipeline 100 illustrated in FIG. 1 for efficiently approximating a target function (e.g., a target function defining an amplifier architecture as illustrated in FIG. 2, a target function defining a neural network or other machine learning models, as illustrated in FIGS. 3 and/or 4, or the like) and generating a result using the approximation of the target function. Operations 500 may be performed by a computing device including one or more processors, such as a processing system 600 illustrated in FIG. 6.

As illustrated, the operations 500 begin at block 505 with generating a plurality of sample points from a multi-dimensional space representing a target function. Each respective sample point of the plurality of sample points may be generated based on one or more selected sampling rates for each dimension in the multi-dimensional space.

The operations 500 then proceed to block 510 with generating a plurality of sparse matrices from the plurality of sample points. Generally, each respective sparse matrix of the plurality of sparse matrices may be generated based on the known non-zero coefficients of the target function.

The operations 500 then proceed to block 515 with generating a plurality of transformed sparse matrices. The transformed sparse matrices generally represent a relationship between Chebyshev coefficients of the target function and the plurality of sparse matrices representing the plurality of sample points after applying a cosine transformation.

The operations 500 then proceed to block 520 with generating an approximation of the target function based on the plurality of transformed sparse matrices.

The operations 500 may then proceed to block 525 with taking one or more actions based on the approximation of the target function.

In some aspects, the one or more actions may include identifying values of various parameters of an amplifier including a DPD and PA. As discussed, the output of an amplifier including a DPD and PA may be represented by the target function y(t)=ƒ_{PA}(ƒ_{PD}(·|u(t))), and the operations 500 may be performed based on empirical or test data to identify optimal parameters for one or both of the DPD and/or the PA (e.g., the DPD 205 and/or PA 210 illustrated in FIG. 5). The optimal parameters for the DPD and/or the PA may, in some aspects, correspond to Chebyshev coefficients of the target function and may control how the amplifier applies digital predistortion and/or amplification to a signal prior to outputting the signal for transmission (e.g., by an antenna communicatively coupled with the amplifier).

In some aspects, the one or more actions may include identifying weights, biases, and/or other parameters of a machine learning model, such as the convolutional neural network 350 illustrated in FIG. 3 and/or the transformer architecture 400 illustrated in FIG. 4. The operations 500 described herein may be used, for example, to train or re-train a machine learning model or a portion thereof. For example, known locations Chebyshev coefficients may be associated with different convolution layers 356, different fully connected layers 362, and/or the logistic regression layer 364 in the convolutional neural network 350 (as well as other layers not illustrated in FIG. 3). Training or re-training the convolutional neural network 350 may be based on, for example, an identification of the weights, biases, and/or other parameters as known locations of Chebyshev coefficients based on which a function defining the convolutional neural network 350 can be approximated. The resulting approximation of the convolutional neural network 350 may, in some aspects, be deployed to another device for inferencing operations, such that the values of these Chebyshev coefficients are used as the weights, biases, and/or other parameters applied to an input into the convolutional neural network.

In another example, as discussed above with respect to FIG. 4, equations defining the attention output of a transformer architecture 400 may be approximated using the operations 500 discussed herein. The known locations of Chebyshev coefficients may, for example, correspond to weights and/or biases associated with the queries Q 422, the keys K 424, and/or the values V 426. As with the discussion of training the convolutional neural network 350 above, training the transformer architecture 400 may result in an approximation of a function defining the output of the transformer architecture 400. The resulting approximation of the function defining the output of the transformer architecture 400 may be deployed to another device for inferencing operations, such that the values of these Chebyshev coefficients are used as the weights, biases, and/or other parameters applied to one or more of the query, key, and/or value inputs of the transformer architecture 400.

In some aspects, generating the respective sample point includes generating a respective grid in the multi-dimensional space based on the one or more selected sample rates for each dimension in the multi-dimensional space. The respective sample point may be generated based on locations of each intersection in the generated grid. In some aspects, the respective grid may include a sample corresponding to a tensor product of a plurality of sub-grids in the respective grid. For example, as illustrated in FIG. 1, the tensor product grid 110 may include a plurality of sub-grids defined by different points in the tensor product grid 110.

In some aspects, the one or more sampling rates for each dimension in the multi-dimensional space are selected such that a total number of samples in each of the plurality of samples is proportional to a total number of non-zero polynomial coefficients in the target function.

In some aspects, the number of sparse matrices in the plurality of sparse matrices is related to a number of Chebyshev coefficients that represent the target function.

In some aspects, generating the output of the at least the portion of the neural network comprises generating the output based on a sparse Chebyshev transformation of the target function and each respective non-zero Chebyshev coefficient of the target function.

In some aspects, each respective sparse matrix comprises a matrix including a majority of zero values.

In some aspects, generating the plurality of transformed matrices comprises applying a discrete cosine transform (DCT) to each sparse matrix of the plurality of sparse matrices.

In some aspects, generating the approximation of the target function comprises: generating a linear system based on the plurality of transformed matrices multiplied by the plurality of sparse matrices multiplied by polynomial coefficients associated with the target function, the polynomial coefficients including a plurality of known coefficients and a plurality of unknown coefficients; and solving for the plurality of unknown coefficients in the target function based on an iterative solver (e.g., an iterative process discussed above).

Note that FIG. 5 is just one example of a method, and other methods including fewer, additional, or alternative steps are possible consistent with this disclosure.

### Example Processing Systems for Fast Chebyshev Transform-Based Interpolation of a Target Function

FIG. 6 depicts an example processing system 600 that may be configured to perform aspects of the techniques described herein for computationally efficient approximation and solving of a target function (e.g., target functions defining an amplifier architecture 200 illustrated in FIG. 2, a convolutional neural network 350 illustrated in FIG. 3, a transformer architecture 400 illustrated in FIG. 4, or the like), including, for example, the operations 500 illustrated in FIG. 5.

The processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

The processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as the NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), or vision processing unit (VPU).

NPUs, such as the NPU 608, may be configured to accelerate the performance of common machine learning tasks, such as image classification, sound classification, and various other predictive models. In some examples, a plurality of NPUs may be instantiated on a single chip, such as a system on a chip (SoC), while in other examples NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components/units, which may be executed by one or more of the aforementioned processors of the processing system 600.

In this example, the memory 624 includes a sample point generating unit 624A, an approximation generating unit 624B, a sparse matrix generating component 624C, a sparse matrix transforming component 624D, an optional neural network component 624E, and an optional RF circuit parameter determining component 624F. The depicted components/units, and others not depicted, may be configured to perform various aspects of the methods described herein.

The processing system 600 is just one example and may generally perform operations (e.g., of a server and/or clients) described herein. However, in other aspects, certain aspects may be omitted. For example, a server may omit certain features that may be regularly found in a mobile device, such as the multimedia processing unit 610, the wireless connectivity component 612, the antenna 614, the sensor processing units 616, the ISPs 618, and the navigation processor 620.

Generally, the processing system 600 and/or components thereof may be configured to perform the methods described herein.

### Example Clauses

Implementation examples are described in the following numbered clauses:

Clause 1: A computer-implemented method, comprising: generating a plurality of sample points from a multi-dimensional space representing domain of a target function, each respective sample point of the plurality of sample points being generated based on one or more selected sampling rates for each dimension in the multi-dimensional space; generate a plurality of sparse matrices from the plurality of sample points, each respective sparse matrix of the plurality of sparse matrices being generated based on known locations of non-zero coefficients of the target function. generating a plurality of transformed sparse matrices representing a relationship between Chebyshev coefficients of the target function and the plurality of sparse matrices representing the plurality of sample points after applying a cosine transformation; generating an approximation of the target function based on the plurality of transformed sparse matrices; and taking one or more actions based on the approximation of the target function.

Clause 2: The method of Clause 1, wherein generating the respective sample point comprises: generating a respective grid in the multi-dimensional space based on the one or more selected sample rates for each dimension in the multi-dimensional space; and generating the respective sample point based on locations of each intersection in the generated grid.

Clause 3: The method of Clause 2, wherein: the respective grid comprises a sample corresponding to a tensor product of a plurality of sub-grids in the respective grid.

Clause 4: The method of any of Clauses 1 through 3, wherein the one or more sampling rates for each dimension in the multi-dimensional space is selected such that a total number of samples in each of the plurality of samples is proportional to a total number of non-zero polynomial coefficients in the target function.

Clause 5: The method of any of Clauses 1 through 4, wherein a number of sparse matrices in the plurality of sparse matrices is related to a number of Chebyshev coefficients representing the target function.

Clause 6: The method of Clause 5, wherein generating the output of the at least the portion of the neural network comprises generating the output based on a sparse Chebyshev transformation of the target function and each respective non-zero Chebyshev coefficient of the target function.

Clause 7: The method of any of Clauses 1 through 6, wherein each respective sparse matrix comprises a matrix including a majority of zero values.

Clause 8: The method of any of Clauses 1 through 7, wherein generating the plurality of transformed matrices comprises applying a discrete cosine transform (DCT) to each sparse matrix of the plurality of sparse matrices.

Clause 9: The method of any of Clauses 1 through 8, wherein generating the approximation of the target function comprises: generating a linear system based on the plurality of transformed matrices multiplied by the plurality of sparse matrices and multiplied by polynomial coefficients associated with the target function, the polynomial coefficients including a plurality of known locations of coefficients and a plurality of unknown values of the coefficients; and solving for the plurality of unknown coefficients in the target function based on an iterative solver.

Clause 10: The method of any of Clauses 1 through 9, wherein the one or more actions comprises: identifying parameters of one or more components of a signal amplifier based on test data associated with the signal amplifier, and configuring the amplifier to generate an output signal for transmission via an antenna based on the identified parameters.

Clause 11: The method of Clause 10, wherein the identified parameters comprise parameters associated with a digital predistorter portion of the signal amplifier.

Clause 12: The method of Clauses 10 or 11, wherein the identified parameters comprise parameters associated with a power amplifier portion of the signal amplifier.

Clause 13: The method of any of Clauses 1 through 12, wherein the one or more actions comprises: identifying parameters of a convolutional neural network associated with one or more layers of the convolutional neural network, and deploying the approximation of the target function defining the convolutional neural network for inferencing operations.

Clause 14: The method of any of Clauses 1 through 13, wherein the one or more actions comprises: identifying parameters of a transformer neural network associated with a self-attention block of the convolutional neural network, and deploying the approximation of the target function defining the transformer neural network for inferencing operations.

Clause 15: A system, comprising: a memory having executable instructions stored thereon; and a processor configured to execute the executable instructions in order to cause the system to perform the operations of any of Clauses 1 through 14.

Clause 16: A system comprising means for performing the operations of any of Clauses 1 through 14.

Clause 17: A computer-readable medium having instructions stored thereon which, when executed by one or more processors of a processing system, cause the processing system to perform the operations of any of Clauses 1 through 14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
generate a plurality of sample points from a multi-dimensional space representing a domain of a target function, each respective sample point of the plurality of sample points being generated based on one or more selected sampling rates for each dimension in the multi-dimensional space;
generate a plurality of sparse matrices from the plurality of sample points, each respective sparse matrix of the plurality of sparse matrices being generated based on known locations of non-zero coefficients of the target function;
generate a plurality of transformed sparse matrices representing a relationship between Chebyshev coefficients of the target function and the plurality of sparse matrices representing the plurality of sample points after applying a cosine transformation;
generate an approximation of the target function based on the plurality of transformed sparse matrices; and
generate an output of at least a portion of a neural network based on the approximation of the target function.

2. The processing system of claim 1, wherein to generate the respective sample point, the one or more processors are configured to cause the processing system to:
generate a respective grid in the multi-dimensional space based on the one or more selected sample rates for each dimension in the multi-dimensional space; and
generate the respective sample point based on locations of each intersection in the generated grid.

3. The processing system of claim 2, wherein: the respective grid comprises a sample corresponding to a tensor product of a plurality of sub-grids in the respective grid.

4. The processing system of claim 1, wherein the one or more sampling rates for each dimension in the multi-dimensional space are selected such that a total number of samples in each of the plurality of samples is proportional to a total number of non-zero polynomial coefficients in the target function.

5. The processing system of claim 1, wherein a number of sparse matrices in the plurality of sparse matrices is related to a number of Chebyshev coefficients representing the target function.

6. The processing system of claim 5, wherein to generate the output of the at least the portion of the neural network, the one or more processors are configured to cause the processing system to generate the output based on a sparse Chebyshev transformation of the target function and each respective non-zero Chebyshev coefficient of the target function.

7. The processing system of claim 1, wherein each respective sparse matrix comprises a matrix including a majority of zero values.

8. The processing system of claim 1, wherein to generate the plurality of transformed matrices, the one or more processors are configured to cause the processing system to apply a discrete cosine transform (DCT) to each sparse matrix of the plurality of sparse matrices.

9. The processing system of claim 1, wherein to generate the approximation of the target function, the one or more processors are configured to cause the processing system to:
generate a linear system based on the plurality of transformed matrices multiplied by the plurality of sparse matrices and multiplied by polynomial coefficients associated with the target function, the polynomial coefficients including a plurality of known locations of coefficients and a plurality of unknown values of the coefficients; and
solve for the plurality of unknown coefficients in the target function based on an iterative solver.

10. The processing system of claim 1, wherein to perform the one or more actions, the one or more processors are configured to cause the processing system to:
identify parameters of one or more components of a signal amplifier based on test data associated with the signal amplifier, and
configure the amplifier to generate an output signal for transmission via an antenna based on the identified parameters.

11. The processing system of claim 10, wherein the identified parameters comprise parameters associated with a digital predistorter portion of the signal amplifier.

12. The processing system of claim 10, wherein the identified parameters comprise parameters associated with a power amplifier portion of the signal amplifier.

13. The processing system of claim 1, wherein to perform the one or more actions, the one or more processors are configured to cause the processing system to:
identify parameters of a convolutional neural network associated with one or more layers of the convolutional neural network, and
deploy the approximation of the target function defining the convolutional neural network for inferencing operations.

14. The processing system of claim 1, wherein to perform the one or more actions, the one or more processors are configured to cause the processing system to:
identify parameters of a transformer neural network associated with a self-attention block of the convolutional neural network, and
deploy the approximation of the target function defining the transformer neural network for inferencing operations.

15. A computer-implemented method, comprising:
generating a plurality of sample points from a multi-dimensional space representing a domain of a target function, each respective sample point of the plurality of sample points being generated based on one or more selected sampling rates for each dimension in the multi-dimensional space;
generating a plurality of sparse matrices from the plurality of sample points, each respective sparse matrix of the plurality of sparse matrices being generated based on known locations of non-zero coefficients of the target function;
generating a plurality of transformed sparse matrices representing a relationship between Chebyshev coefficients of the target function and the plurality of sparse matrices representing the plurality of sample points after applying a cosine transformation;
generating an approximation of the target function based on the plurality of transformed sparse matrices; and
generating an output of at least a portion of a neural network based on the approximation of the target function.

16. The method of claim 15, wherein generating the respective sample point comprises:
generating a respective grid in the multi-dimensional space based on the one or more selected sample rates for each dimension in the multi-dimensional space; and
generating the respective sample point based on locations of each intersection in the generated grid.

17. The method of claim 16, wherein: the respective grid comprises a sample corresponding to a tensor product of a plurality of sub-grids in the respective grid.

18. The method of claim 15, wherein the one or more sampling rates for each dimension in the multi-dimensional space are selected such that a total number of samples in each of the plurality of samples is proportional to a total number of non-zero polynomial coefficients in the target function.

19. The method of claim 15, wherein a number of sparse matrices in the plurality of sparse matrices is related to a number of Chebyshev coefficients representing the target function.

20. The method of claim 19, wherein generating the output of the at least the portion of the neural network comprises generating the output based on a sparse Chebyshev transformation of the target function and each respective non-zero Chebyshev coefficient of the target function.

21. The method of claim 15, wherein each respective sparse matrix comprises a matrix including a majority of zero values.

22. The method of claim 15, wherein generating the plurality of transformed matrices comprises applying a discrete cosine transform (DCT) to each sparse matrix of the plurality of sparse matrices.

23. The method of claim 15, wherein generating the approximation of the target function comprises:
generating a linear system based on the plurality of transformed matrices multiplied by the plurality of sparse matrices and multiplied by polynomial coefficients associated with the target function, the polynomial coefficients including a plurality of known locations of coefficients and a plurality of unknown values of the coefficients; and
solving for the plurality of unknown coefficients in the target function based on an iterative solver.

24. The method of claim 15, wherein the one or more actions comprises:
identifying parameters of one or more components of a signal amplifier based on test data associated with the signal amplifier, and
configuring the amplifier to generate an output signal for transmission via an antenna based on the identified parameters.

25. The method of claim 24, wherein the identified parameters comprise parameters associated with a digital predistorter portion of the signal amplifier.

26. The method of claim 24, wherein the identified parameters comprise parameters associated with a power amplifier portion of the signal amplifier.

27. The method of claim 15, wherein the one or more actions comprises:
identifying parameters of a convolutional neural network associated with one or more layers of the convolutional neural network, and
deploying the approximation of the target function defining the convolutional neural network for inferencing operations.

28. The method of claim 15, wherein the one or more actions comprises:
identifying parameters of a transformer neural network associated with a self-attention block of the convolutional neural network, and
deploying the approximation of the target function defining the transformer neural network for inferencing operations.

29. A processing system, comprising:
means for generating a plurality of sample points from a multi-dimensional space representing a domain of a target function, each respective sample point of the plurality of sample points being generated based on one or more selected sampling rates for each dimension in the multi-dimensional space;
means for generating a plurality of sparse matrices from the plurality of sample points, each respective sparse matrix of the plurality of sparse matrices being generated based on known locations of non-zero coefficients of the target function;
means for generating a plurality of transformed sparse matrices representing a relationship between Chebyshev coefficients of the target function and the plurality of sparse matrices representing the plurality of sample points after applying a cosine transformation;
means for generating an approximation of the target function based on the plurality of transformed sparse matrices; and
means for generating an output of at least a portion of a neural network based on the approximation of the target function.

30. A non-transitory computer-readable medium having executable instructions stored thereon which, when executed by one or more processors, performs an operation comprising:
generating a plurality of sample points from a multi-dimensional space representing a domain of a target function, each respective sample point of the plurality of sample points being generated based on one or more selected sampling rates for each dimension in the multi-dimensional space;
generating a plurality of sparse matrices from the plurality of sample points, each respective sparse matrix of the plurality of sparse matrices being generated based on known locations of non-zero coefficients of the target function;
generating a plurality of transformed sparse matrices representing a relationship between Chebyshev coefficients of the target function and the plurality of sparse matrices representing the plurality of sample points after applying a cosine transformation;
generating an approximation of the target function based on the plurality of transformed sparse matrices; and
generating an output of at least a portion of a neural network based on the approximation of the target function.
